(19) United States
(12) Patent Application Publication
(10) Pub. No.: US 2017/0023101 A1
(43) Pub. Date: Jan. 26, 2017

(54) ENDLESS BELT FOR CONVEYOR BELTS OF AGRICULTURAL MACHINES

(71) Applicant: ARTEMIS Kautschuk-und Kunststoff-Technik GmbH, Hannover (DE)

(72) Inventors: SEBASTIAN JÄGER, HANNOVER (DE); NICK SCHMIDT, LEHRTE (DE)

(21) Appl. No.: 15/095,096

(22) Filed: Apr. 10, 2016

(30) Foreign Application Priority Data
Apr. 9, 2015 (EP) 15162936.7

(51) Int. Cl. F16G 3/08

(52) U.S. Cl. CPC F16G 3/08

(57) ABSTRACT

A belt as an endless traction device for conveyor belts of agricultural machines, the belt being made of a polymer that is reinforced by fabric plies. Endless belt provides a conveyor belt of this type which has high static and dynamic strength at the connecting point, combined with great bending flexibility. This is achieved in that at least one fabric ply of each belt end, folded back on itself, wraps around a thickened area and extends between the thickened area and a stop, which forms an abutment with respect to the thickened area, in such a way that the fabric ply is jammed between the thickened area and the stop when tension acts on the belt in the reverse direction.

### CROSS-REFERENCE TO RELATED APPLICATIONS

This application claims priority of European application no. 15162936.7, filed Apr. 9, 2015, and which is incorporated herein by reference.

### FIELD OF THE INVENTION

The present invention relates to endless belts for conveyor belts of agricultural machines.

### BACKGROUND OF THE INVENTION

Conveyor belts for agricultural machines usually have two or more belts of this type which are situated in parallel to one another and joined together by transverse elements such as rods. These belts must be in an endless form in order to be used. Various procedures are known from the prior art for producing such an endless form.

Thus, it is known from DE 100 37 640 A1 to intermesh the two ends of a belt in a comb-like manner, and to push one intermeshed area into the other, followed by vulcanization, for making the belt endless.

In DE 297 16 331 U1 and DE 10 2006 022 011 B3, a traction means designed as a cam belt is made endless by use of a belt fastener. Belt fasteners of this type are often used in various embodiments for making an endless traction means for conveyor belts of agricultural machines.

A flat belt made of a polymer reinforced with fabric plies is known from DE 10 2011 116 633 A1. This belt is made endless by graduating it multiple times at both ends over the entire width. This results in an overlap area in which an outer belt end and an inner belt end lie one on top of the other in an overlapping manner. On its bottom side, the belt has grooves which extend transversely with respect to the longitudinal direction at uniform intervals, and which are used in the overlap area for accommodating anchor plates. Each anchor plate has two welded-on threaded bolts that are spaced apart from one another. When the inner belt end and the outer belt end are placed one on top of the other, these threaded bolts protrude into mutually aligned holes provided in the outer belt end and in the inner belt end. Nuts are screwed onto the ends of the threaded bolts which protrude from the belt and are tightened, as the result of which the outer belt end and the inner belt end are tightly pressed against one another for transmitting tensile forces. To further improve the tensile strength at the connecting point, in one embodiment, toothed elements which are vulcanized on in the overlap area at the inner belt end and at the outer belt end are provided, and interlock with a positive fit when the connection between the inner belt end and the outer belt end is established.

The belt known from DE 10 2011 116 633 A1 has high static and dynamic strength in the overlap area. This is achieved, among other ways, in that the overlap area is relatively long, which, however, adversely affects the bending flexibility of the belt, which is necessary in deflection areas.

DE 10 2009 036 104 A1 discloses an inclined conveyor for combine harvesters, having at least two cam belts which are connected to one another by carrier bars. The carrier bars are fastened to the belt by a screw connection. For this purpose, the heads of two threaded bolts in each case together with an anchor plate are vulcanized into a cam. The carrier bars, which are provided with holes at this location, are then placed on the ends of the threaded bolts which protrude from the belt from the other side, and are subsequently fastened to the belt by screwing on nuts. As the result of the screw heads and the anchor plates being embedded in the cams, this portion of the screw connection on the one hand is protected from wear. On the other hand, noise at the drive wheels and deflection wheels is reduced, since there is no metal-to-metal contact.

### OBJECTS AND SUMMARY OF THE INVENTION

The object of the present invention is to provide a belt of the generic type which has high static and dynamic strength at the connecting point, combined with great bending flexibility.

This object is achieved with a belt having the features of Claim 1.

In an endless belt according to the invention, the connecting point may have a very short design in the longitudinal direction of the belt, since its dimensioning in this regard is determined only by the relatively small transverse dimensions of the two adjacently situated thickened areas and the stops associated therewith. As a result, the belt which is made endless has great bending flexibility at its connecting point, which has a positive effect on the running performance of the belt at deflection points. Despite the short connecting point, very high tensile forces may be transmitted, since the at least one fabric ply pulls the thickened area, which it wraps around, against the associated stop when the belt is tensioned, thus clamping the at least one fabric ply between the thickened area and the stop. The higher the tensile force that acts on the belt, the greater the clamping effect on the fabric ply.

In one particularly advantageous embodiment of the invention, the thickened areas are situated in a cage that is formed by a first and a second half shell, the first half shell being situated on the outer side of the belt and the second half shell being situated on the inner side of the belt. The cage may have a one-piece design, in which case the two half shells are open at an end-face side of the cage, and closed at the other end-face side. However, the cage may also have a two-piece design, in which case the two half shells in the assembled state are joined together by screwing or in some other way, so that they cannot be pushed apart under stress due to tension on the belt.

Since the connecting point may have a very short design, when the belt is a cam belt it is possible to provide the second half shell, situated on the inner side of the belt, with the shape of a drive cam which fits into a predefined gap.

However, the first half shell on the outer side of the belt may also be formed by the flattened end of a transverse rod which connects two belts, in which case the two belts are made endless by fastening the transverse rod. Alternatively, the first half shell on the outer side of the belt may be provided with the shape of a flattened end of a transverse rod which connects two belts, and which is provided on an end-face side, in one piece with a bushing into which one end of a transverse rod is inserted during assembly of the conveyor belt.

Bodies which are suitable as thickened areas have material properties such that, when tension acts on the belt, the bodies are not compressed at all, or are only compressed to the extent that their degree of compression still ensures jamming of the at least one fabric ply. Rigid rods are preferably used. However, flexible bodies having the above-mentioned property may also be used.

Advantageous further embodiments of the invention result from the other dependent claims.

### BRIEF DESCRIPTION OF THE DRAWINGS

The invention is explained in greater detail below, based on the embodiments. The associated drawings show the following:

FIG. 1 shows a side view of a connecting point of a belt made endless according to a first embodiment of the invention,

FIG. 2 shows a top view of the illustration according to FIG. 1,

FIG. 3 shows a perspective view of the connecting point according to FIGS. 1 and 2,

FIG. 4 shows a cross section of a connecting point according to a second embodiment of the invention,

FIG. 5 shows a cross section of a connecting point according to a third embodiment of the invention,

FIG. 6 shows a perspective view of a connecting point of a belt according to a fourth embodiment of the invention,

FIG. 7 shows a side view of a connecting point of a belt according to a fifth embodiment of the invention,

FIG. 8 shows a top view of the illustration according to FIG. 7,

FIG. 9 shows a perspective view of the connecting point according to FIGS. 7 and 8, and

FIG. 10 shows a perspective view of a cage that is provided for a connecting point.

Relative terms such as left, right, up, and down are for convenience only and are not intended to be limiting.

### DETAILED DESCRIPTION OF THE INVENTION

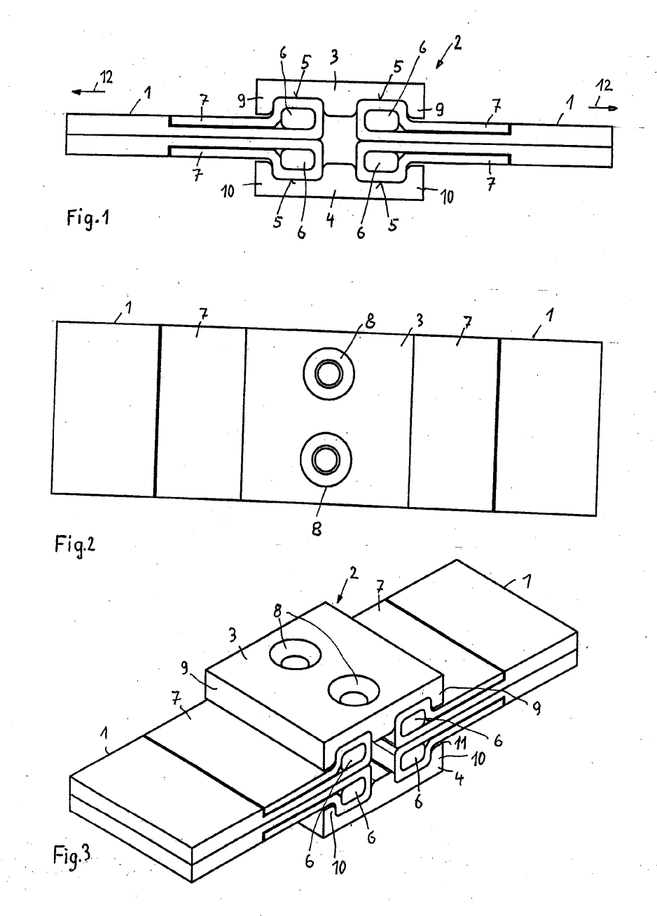

In the embodiment illustrated in FIGS. 1 to 3, a cage 2 made of steel is used at the connecting point of a belt 1. This cage 2 is made up of a first half shell 3 situated on the outer side of the belt 1 and a second half shell 4 situated on the inner side of the belt 1. Both half shells 3, 4 have channel-like depressions 5 which are used for accommodating steel rods 6.

The belt 1 is made of a polymer that is reinforced by fabric plies 7, the fabric plies 7 on the outer side and the inner side of the belt 1 being covered by a polymer layer. For creating the connecting point, these polymer layers are removed on both belts so that the fabric plies 7 are exposed at this location.

On each belt end, on the outer side and the inner side of the belt 1 in each case at least one fabric ply 7 is wrapped around a steel rod 6 and folded back on itself, as is clearly apparent from FIG. 1. The rods 6 wrapped around in this way are subsequently inserted into the cage 2. The two half shells 3, 4 are then screwed together by means of two screws, not illustrated. For this purpose, two countersunk holes 8 for the screw heads are provided in the first half shell 3, and threaded holes, not visible in the illustration, are provided in the second half shell 4. When the half shells 3, 4 are screwed together, a gap 11 remains between their side walls 9 and 10, respectively, for the fabric plies 7 which are folded back on themselves to pass through. When tension is exerted on the belt in the reverse direction (arrows 12 in FIG. 1), the rods 6 together with the fabric plies 7 situated in between are pulled against the side walls 9, 10 of the half shells 3, 4 which act as stops, thus clamping the fabric plies 7 between the rods 6 and the side walls 9, 10.

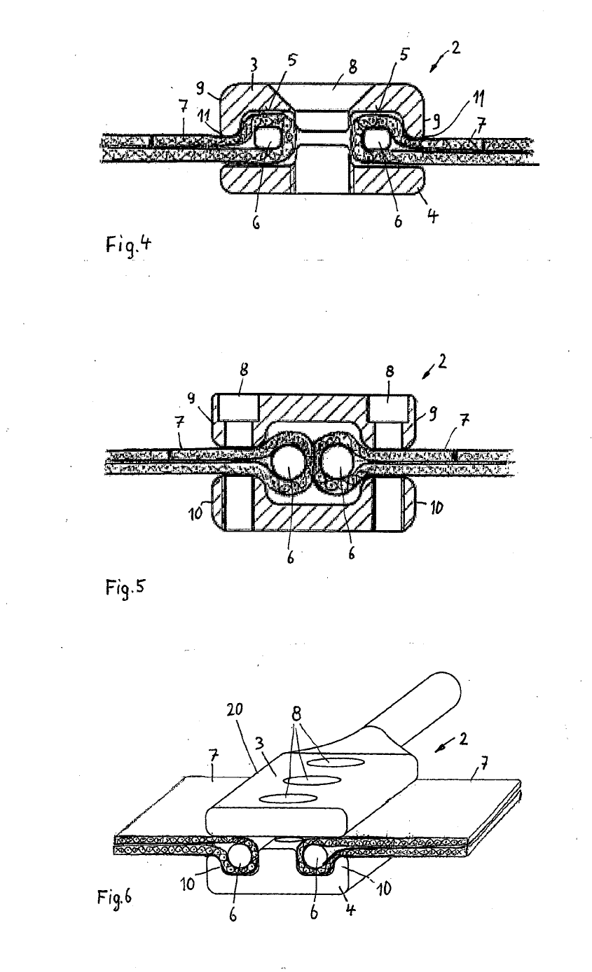

The embodiment illustrated in FIG. 4 differs from the embodiment discussed above, solely in that for each belt end, in each case only one rod 6 is inserted into the cage 2.

Although the rods 6 according to the embodiments in FIGS. 1 to 4 are illustrated with a quadrangular cross section, a circular cross section is preferred.

In the embodiment according to FIG. 5, for each belt end in each case only one rod 6 is likewise inserted into the cage 2.

In this case, however, the two half shells 3, 4 are screwed together not between the rods 6, but, rather, in each case in the area on the fabric plies 7 which are folded back on themselves.

In the embodiments described above, the cage 2 has a two-piece design; i.e., the two half shells 3, 4 are two separate components. However, the cage 2 may also be in one piece, in that the two half shells 3, 4 are rigidly connected to one another by an end-face wall 19 at an end-face side, while the cage 2 is open on the oppositely situated end-face side in order to insert the rods 6. This type of cage is illustrated in FIG. 10. In this case, screwing together of the two half shells 3, 4 may be dispensed with.

The embodiment shown in FIG. 6 essentially corresponds to the embodiment according to FIG. 4; in the former embodiment, the two half shells 3, 4 are not only used for connecting the two belt ends, but also take on additional functions. The second half shell 4 situated on the inner side of the belt 1 may thus have the external shape of a drive cam. Thus, for a belt 1 designed as a cam belt, the half shell 4 may at the same time be used as a drive cam which fits into the gap.

In this embodiment, the first half shell 3 situated on the outer side of the belt 1 also has the shape of a flattened end 20 of a transverse rod which connects two belts, and which is provided on an end-face side, in one piece with a bushing 13 which may receive one end of a transverse rod (without flattened ends) during assembly of a conveyor belt.

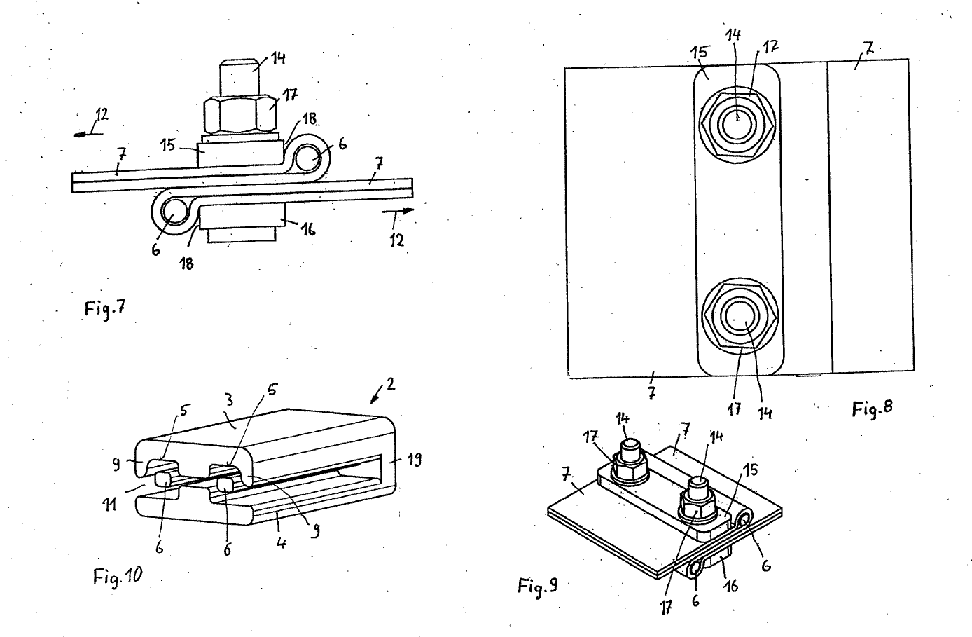

In the embodiment illustrated in FIGS. 7 to 9, the polymeric cover layer of the belt 1 is removed on one side at both ends of the belt 1 in order to expose the fabric plies 7. At least one of the exposed fabric plies 7 is folded back on itself at both ends of the belt 1, and wrapped around a steel rod 6, as most clearly shown in FIG. 7. The two belt ends are then placed one on top of the other in an overlapping manner in the areas which are folded back on themselves, and are provided with two through holes which are spaced apart from one another in the transverse direction of the belt 1. Fastening screws 14 are then inserted through these through holes, with a first clamping plate 15 and a second clamping plate 16 in between. The assembly comprising the fabric plies 7 which are folded back on themselves, situated between the first clamping plate 15 and the second clamping plate 16, is then jammed by screwing on a nut 17. Due to a tension on the belt 1 which acts in the reverse direction (arrows 12 in FIG. 7), the rods 6 which are wrapped around by the fabric plies are pulled against an adjoining side wall 18 of the clamping plates 15 and 16, which represent a stop. The fabric plies 7 situated between the rods 6 and the side walls 18 are thus jammed.

In all embodiments, the rods 6 are inserted loosely into the fabric plies 7, and are only held in position by same. Alternatively, the rods 6 may be vulcanized into the fabric plies 7.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

What is claimed is:

1. An endless belt for conveyor belts of agricultural machines, wherein the belt is made of a polymer that is reinforced by fabric plies, and at least one fabric ply of each belt end, folded back on itself, wraps around a thickened area and extends between the thickened area and a stop, which forms an abutment with respect to the thickened area, in such a way that the fabric ply is jammed between the thickened area and the stop when tension acts on the belt in the reverse direction.

2. The belt according to claim 1, wherein the thickened areas which are wrapped around by the at least one fabric ply are inserted into a cage which is formed in one piece by a first half shell and a second half shell, in the assembled state the first half shell being situated on the outer side of the belt and the second half shell being situated on the inner side of the belt, and both half shells are joined together in one piece at an end-face side of the cage, while the other end-face side of the cage is open, a gap being situated in both side walls of the cage which face in the longitudinal direction of the belt for the at least one fabric ply folded back on itself to pass through, and the side walls forming the stop for the respective adjoining thickened area with the at least one fabric ply situated in between.

3. The belt according to claim 1, wherein the thickened areas which are wrapped around by the at least one fabric ply are inserted into a cage which is formed in two pieces by a first half shell and a second half shell, in the assembled state the first half shell being situated on the outer side of the belt and the second half shell being situated on the inner side of the belt, and both half shells are screwed together, a gap being situated in both side walls of the cage which face in the longitudinal direction of the belt for the at least one fabric ply folded back on itself to pass through, and the side walls forming the stop for the respective adjoining thickened area with the at least one fabric ply situated in between.

4. The belt according to claim 1, wherein the fabric plies folded back on themselves, of which there is at least one, of the two belt ends lie one on top of the other in an overlapping manner, and are situated in the overlap area between a first clamping plate situated on the outer side of the belt and a second clamping plate situated on the inner side of the belt, which are screwed together, a side wall of the clamping plates which extends transversely with respect to the longitudinal direction of the belt forming the stop for the respective adjoining thickened area with the at least one fabric ply situated in between.

5. The belt according to claim 2, wherein the second half shell situated on the inner side of the belt has the shape of a drive cam.

6. The belt according to claim 2, wherein the first half shell situated on the outer side of the belt is formed by a flattened end of a transverse rod which connects two belts.

7. The belt according to claim 1, wherein the thickened area is formed by a flexible body having dimensions such that even its compressed dimensions ensure jamming of the at least one fabric ply.

8. The belt according to claim 1, wherein the thickened area is formed by a rigid rod.

9. The belt according to claim 8, wherein the rod is inserted loosely into the fabric plies, and is only held in position by same.

10. The belt according to claim 8, wherein the rod is vulcanized into the fabric ply.
